(19) United States
(12) Patent Application Publication
(10) Pub. No.: US 2016/0037822 A1
(43) Pub. Date: Feb. 11, 2016

(54) Dual Drive Juicer

(71) Applicant: BREVILLE PTY LIMITED, Alexandria (AU)

(72) Inventors: Mark Thomas, Leichhardt, NSW (AU); Khon Thai, Campsie, NSW (AU); Samuel Adeloju, (AU); Lochana Subasekara Widanagamage Don, (US)

(21) Appl. No.: 14/782,790

(22) PCT Filed: Apr. 22, 2014
(86) PCT No.: PCT/AU2014/000445

§ 371 Date: Oct. 7, 2015

(30) Foreign Application Priority Data
Apr. 23, 2013 (AU) 2013901411

(51) Int. Cl. A23N 1/02

(52) U.S. Cl. CPC A23N 1/02

(57) ABSTRACT

A juicer combines an augur with a processing disk that breaks down food before it makes contact with the augur.

### FIELD OF THE INVENTION

The technology relates to juice extraction and more particularly to improvements and modifications to a juicer type that is sometimes referred to as a slow juicer or slow press juicer.

### BACKGROUND OF THE INVENTION

Any discussion of the prior art throughout the specification should in no way be considered as an admission that such prior art is widely known or forms part of the common general knowledge in the field.

There are two basic types of fruit and vegetable juicer or juice extractor available for domestic use. A centrifugal juicer uses a rotating grating disk that reduces a food product such as a fruit or vegetable to a slurry of pulp and juice. The mixture of wet pulp and juice is pushed against a rotating filter at high speed. The juice is urged through the filter by centrifugal force and is collected.

The slow press type juicer uses a slow turning auger to crush or squeeze the fruit or vegetable matter. The auger presses the pulp through a stationary filter so that it can be collected.

Centrifugal juicers have the advantage of higher rates of juicing and larger feed tubes that are able to accept many types of whole fruit and vegetables, eliminating the need for pre-cutting. Slow press juicers, although slower, are more efficient at juicing leafy vegetables, wheat grass and leafy herbs.

The present technology attempts to combine the benefits and some aspects and some aspects of centrifugal juicing and slow press juicing into a single device.

An example of a slow press type juice extractor with a tapered auger wiping blades and stationary filter basket can be seen in U.S. Pat. No. 8,091,473 issued to Young-Ki Kim.

### OBJECTS OF THE INVENTION

It is an object of the present technology to overcome or ameliorate at least one of the disadvantages of the prior art, or to provide a useful alternative.

It is an object of the technology in a preferred form to provide a juicing device having a grating disk that operates at a higher speed than a coaxial auger with which it is associated.

It is another object of the technology in a preferred form to provide a slow press type juicing machine with a central full size feed tube.

It is another object of the technology in a preferred form to provide a slow press type juicing machine that is adapted to receive a citrus reamer.

It is another object of the technology in a preferred form to provide a slow press type juicing machine having a juice collection chamber at the bottom of which is an impeller. The impeller is adapted to propel the juice to an elevated spout.

It is a further objection of the technology in a preferred form to provide a slow press type juicing machine in which the auger has a multi-bladed working face adapted to accelerate the breakdown of fruits of vegetables that come into contact with it.

In some preferred embodiments of the technology, the grating disk associated with the auger has a concave face and preferably features a coring blade.

In some preferred embodiments of the technology, the grating disk associated with the auger has a convex face and preferably features a coring blade.

In other embodiments of the technology, there is provided a juicing device having a low speed auger and higher speed grating disk that is removable and replaceable with a citrus reamer. The device is also adapted to receive a fruit dome that is retained by a juicing arm that is carried by a hinge that is attached to the device.

In yet another embodiment of the technology, the otherwise stationer filter basket may be raised and lowered to change the dimensions of a gap through which pulp is ejected into the juice that is being collected. The gap being variable, the quantity of pulp in the juice maybe varied by the user.

In another embodiment of the technology, a feed tube of a slow press juicer has a feed tube with an internal anti-rotation fin.

In some embodiments of the technology, a low speed auger is combined with a coaxial higher speed processing disk. The processing disk may be a grating disk, a slicing disk, a variable thickness slicing disk or a cubing disk.

In some preferred embodiments of the technology, the filter basket is contained within a juice collection chamber. The juice collection chamber is covered by a lid with a feed tube. The lid is retained with a pivoting safety bar. The juice's motor will not rotate unless the safety bar is in its locked and upright orientation.

In other embodiments of the technology, the juicer has a graphic display that provides a graphic indication of a user variable motor speed. In some preferred embodiments, the display also indicates foods that are associated with an indicated motor speed.

In selected embodiments, a grating disk associated with a lower speed auger is fabricated from individual segments, arranged radially, each segment having cutting teeth formed on it. In preferred embodiments, a circular array of segments surrounds a central portion having one or more coring blades. It is an object of the present technology to provide fins or safety features on a feed tube of a fruit and vegetable juicer that limit access to the interior of the feed tube.

It is another object of the technology to provide a ring with the aforementioned features formed on it. The ring may be applied to the upper rim of a feed tube.

Accordingly, there is provided a ring that may be applied to the upper rim of a feed tube, the ring having inwardly directed fingers, the fingers having upper edges that are downwardly inclined.

It is another object of the technology to provide a feed tube for a fruit and vegetable juicer, an upper rim of the feed tube having integral and inwardly directed fins, the fins having upper edges that are downwardly

In other embodiments of the technology, the aforementioned ring is provided with an inwardly extended pusher guide.

In yet other embodiments of the technology, the aforementioned feed tube is provided with an internal and inwardly directed pusher guide.

In other embodiments the upper rim of the feed tube is associated with a plurality of inwardly extending safety features and one of the safety features is vertically aligned with an anti-rotation tin in the feed tube.

### SUMMARY OF THE INVENTION

According to an aspect of the technology there is provided a juicing. machine having a juice collection chamber in which is located a tapered filter basket. A tapered auger is located within the filter basket. The auger is driven by a concentric shaft. An outer portion of the shaft drives the auger and an inner portion of the shaft drives a grating disk or other accessory. In some embodiments of the technology, the grating disk and coaxial shaft arrangement is replaced by the presence of a working face on the auger that has grating or cutting features.

### BRIEF DESCRIPTION OF THE DRAWING FIGURES

In order that the technology be better understood, reference is now made to the following drawing figures in which:

FIG. 1 is a sectional elevation view of an embodiment juice extraction apparatus.

FIG. 2 is a sectional elevation view of an embodiment juice extraction apparatus, shown with a pusher.

FIG. 3 is a sectional elevation view of an embodiment juice extraction apparatus, shown with a non-planar processing disk.

FIG. 4 is a sectional elevation view of an embodiment juice extraction apparatus, shown having a processing disk and pusher having cooperating configurations.

FIG. 5 is a side elevation of a citrus juicing accessory and optional pivot arm and dome.

FIG. 6 is a sectional elevation view of an embodiment juice extraction apparatus, showing user adjustment of pulp entering a juice collection chamber.

FIG. 6A is an exploded prospective view of a juice extraction apparatus with a variable pulp feature.

FIG. 7 is a sectional elevation view of an embodiment juice extraction apparatus, showing an increased juice collection receptacle.

FIG. 8 is a sectional elevation view of an embodiment juice extraction apparatus, showing a processing disk located above the filter basket.

FIG. 9 is a sectional elevation view of an embodiment juice extraction apparatus, showing an auger provided with an upper working surface.

FIG. 10 shows an alternative embodiment auger of FIG. 9.

FIG. 11 shows an alternative embodiment auger of FIG. 9.

FIG. 12 shows an alternative embodiment auger of FIG. 9.

FIG. 13 shows an embodiment concentric shaft arrangement for driving an auger and processing disk of a juice extraction apparatus.

FIG. 14 is an exploded perspective view of an auger with a sweeping blade and a separate and optional processing disk.

FIG. 15 is a side elevation of a juice extraction apparatus having a pivoting safety bar for fixing the lid.

FIG. 16 is a schematic elevation illustrating the user interface of a juice extraction apparatus.

FIG. 17 is a series of three schematic diagrams illustrating the operation of a juice extraction device having a safety bar interlocks.

FIG. 18(a)-(g) are illustrations of a user interface for a juice extraction device.

FIG. 19(a) is a perspective of a grating disc fabricated from multiple segments.

FIG. 19(b) is a side elevation of the grating disc depicted in FIG. 19(a).

FIG. 19(c) is a perspective view of a segment of a grating disc.

FIG. 20(a) is a cross-sectional view of a processing disc having a raping blade.

FIG. 20(b) is a top perspective view of the disc depicted in FIG. 20(a),

FIG. 20(c) is a detail of the huh and blades of the disc illustrated FIG. 20(b).

FIG. 21 is an exploded perspective view of a processing disc having a variable thickness cutting blade.

### BEST MODE AND OTHER EMBODIMENTS

Most slow juicers and in particular, slow press juicers have partial width feed tube. A partial width feed tube is one that is about one half the diameter of the auger within the juicer. The reduced diameter feed tube discourages choking or stalling of the auger with over sized pieces of fruit or vegetable or an excess of food material. Devices of this type generally lack any means of breaking the fruit or vegetable down other than by the action of the auger.

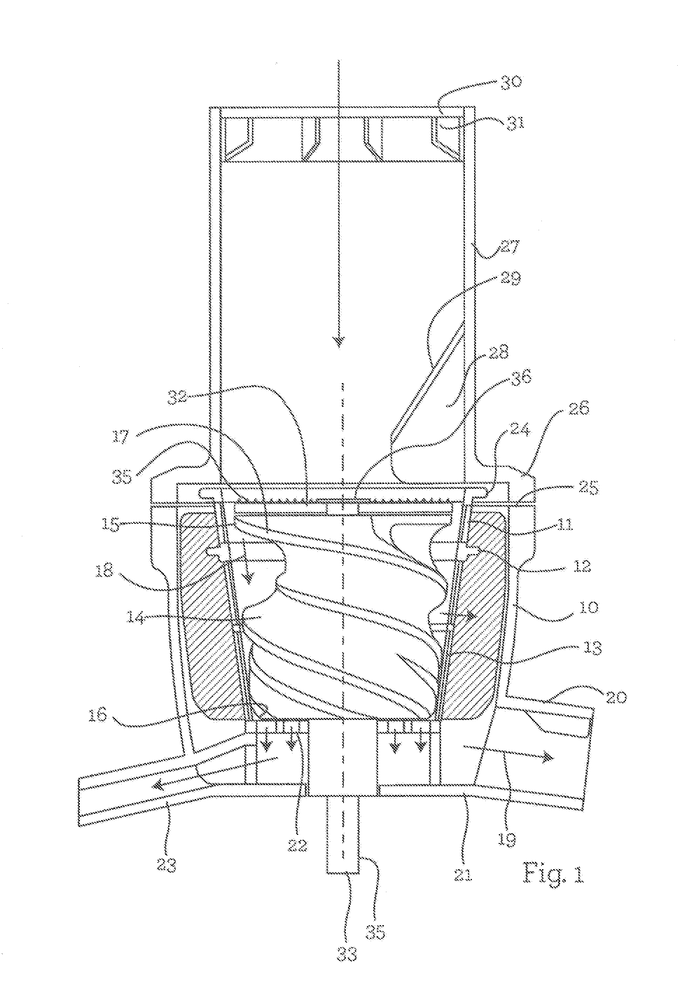

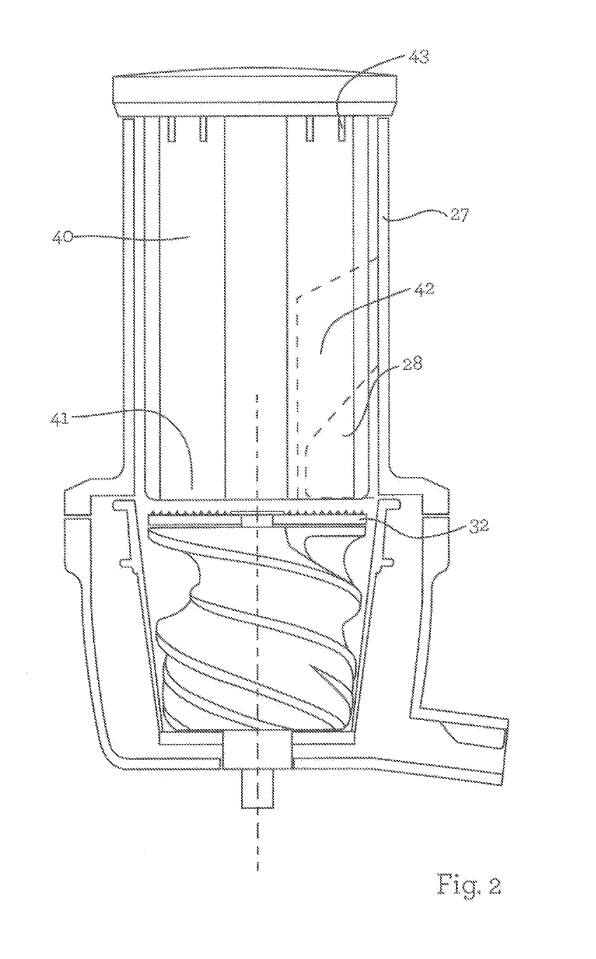

As shown in FIG. 1, the present technology provides a way to break down fruit and vegetable matter before it conies into contact with the auger. As illustrated in FIG. 1, a juicer comprises a juice collection chamber 10 in which is located a stationery filter basket or drum 11. The filter basket 11 comprises a rigid frame 12 that supports a tapered frusto-conical metal filter or sieve 13. Debris on the interior of the collection chamber may be removed with wiping blades as shown in U.S. Pat. No. 8,091,473. A tapered auger with helical threads 14 is supported for rotation within the filler basket 13. The auger 14 has a maximum diameter at its upper or proximal end 15 and a minimum diameter at its lower or distal end 16. The auger is rotated by a motor. Foods are propelled by the auger's threads 17 downward 18. The action of the auger's threads against the interior of the filter basket forces juice through the filter basket 13 into the interior of the juice collecting chamber 10. Accumulated juice is discharged 19 through a spout 20 located toward the base or lower portion 21 Of the juice collection chamber. In preferred embodiments the spout 20 is at the very bottom of the juice collection chamber as shown in FIGS. 2-6. Fruit or vegetable pulp is conveyed by the auger toward the openings at the bottom 22 of the filter basket where it is discharged from a radial pulp discharge chute 23.

The tapered filter drum 13 has an upper rim 24 that is located above the upper rim 25 of the juice collection chamber. The upper rim 25 of the juice collection chamber supports a lid 26 that incorporates a full width feed tube 27. A “full width” feed tube is defined as one whose inside diameter is approximately equal to or only slightly larger or smaller than the maximum diameter of the processing disk, or the auger if there is no processing disk. In this example, the feed tube 27 has an internal anti-rotation fin 28. The fin is attached to and preferably integral with the feed tube and has an inclined edge 29 that may or may not be sharpened. The fin 28 stabilises the contents of the feed tube from excessive rotation within the feed tube. As a safety feature, the internal surface of the feed tube 27 or skirted cap adjacent the upper opening or mouth 30 is provided with inward directed fingers or obstructions 31 that discourage or prevent a hand from entering the feed tube.

FIG. 1 also illustrates how the juicing action is improved and accelerated by a rotating processing disk 32. This grating disk or processing disk 32 is approximately the same diameter as the upper extent 15 of the auger. However, it is supported by and rotated by a second shaft 33 that rotates independently within the cylindrical or tube shaft 34 that rotates the auger 14. The grating disk 32 is preferably metallic and has upward facing teeth 35 as well as a coring knife 36 located centrally on the disk. The configuration of the teeth 35 and coring knife 36 resembles those features found on conventional centrifugal juicing devices such as those provided commercially by the applicant. In some embodiments the processing disk rotates in an opposite direction to the auger.

Because the auger is supported by and rotated by a first shaft 34 and the processing disk 32 is rotated and supported by a second shaft 33, the auger and the processing disk may be and are beneficially operated independently and at considerably different rates of rotation. An optimum rotational rate for the auger is approximately 50-100 rpm. An induction motor, geared down, is preferred, having power pulsed to it in order to achieve lower and also optional variable speed. However, by being separately driven, the processing disk 32 can be operated at speeds hundreds of times faster than the auger. In this example, the processing disk 32 is located, below the rim 24 of the filter basket. Accordingly, the broken down food material created by the processing disk 32 is contained within the filter basket where it is propelled downward by the auger for further processing.

As shown in FIG. 2, the movement of food down or along the feed tube is promoted with a pusher 40. The pusher has a lower surface 41 that terminates just above the teeth of the processing disk 32 when it is fully inserted in the feed tube 27. The pusher 40 is preferably provided with a vertical slot 42 for accommodating the anti-rotation fin 28. It may also be provided with recesses 43 for accommodating the safety fingers 31.

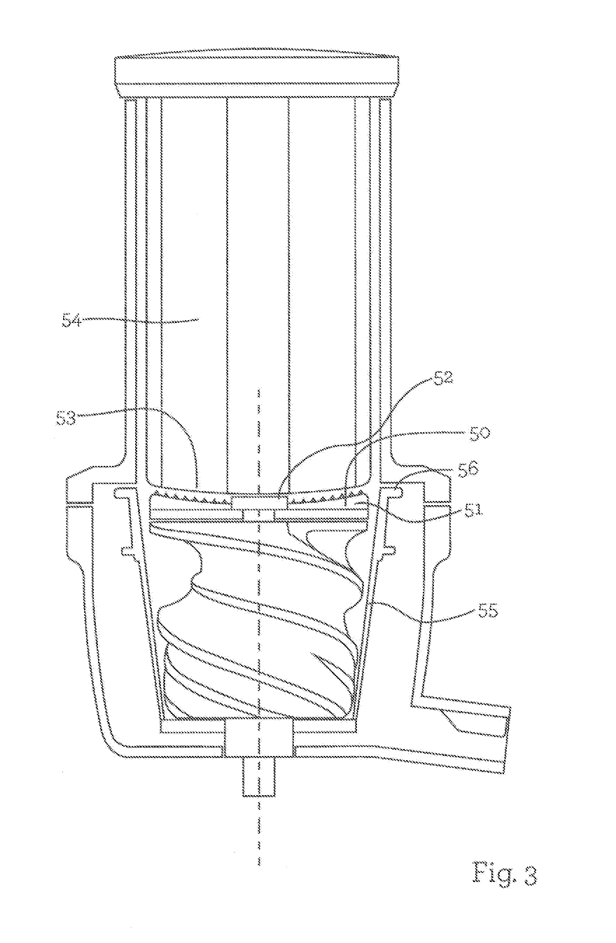

As shown in FIG. 3, the upper surface 50 of the processing disk 51 need not be flat. In this example, the upper surface 50 is slightly concave except for the upper edge of the centrally located coring knife 52 which is flat. Accordingly, the bottom surface 53 of the pusher 54 is shaped conversely to conform to the concave shape of the upper surface of the grating disk 50. The concavity of the processing disk allows for more thorough processing of food material because the food path is longer and food material remains between the grating disk and the pusher for a longer time. Consequently, the trajectory of the material being ejected from between the gap created by the pusher and the grating disk is upward. In preferred embodiments, the uppermost extent of the processing disk 51 is lower than the upper rim 56 of the filter basket 55.

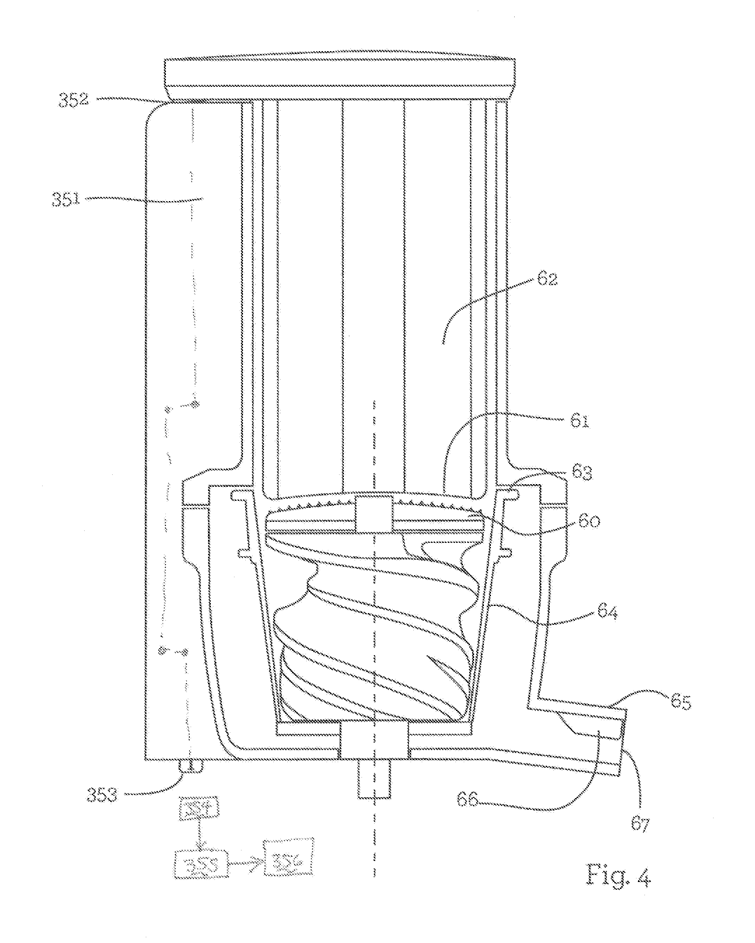

FIG. 4 illustrates another configuration in the cooperating shapes of the processing disk 60 and the bottom 61 of the pusher 62. In this example, the upper surface of the processing disk 60 is convex and the bottom surface 61 of the pusher is concave. As illustrated, the upper extent of the processing disk 60 is below the upper rim 63 of the filter basket 64. In this example, the juice spout 6 is provided with an internal obstruction 66 that prevents a finger or other object from being disadvantageously inserted into the opening 67 of the spout 65.

FIG. 4 also illustrates that the pusher 62 can cooperate with an interlock assembly 351. in this example, the interlock assembly 351 has a mechanical link 352. When the link 352 is depressed by the pusher 62 or otherwise contacted by the pusher 62, allows the juicer's motor to operate for the purpose of rotating the augur or processing disk 60. in this example, the link 352 is mechanically connected to a plunger 353. When the pusher 62 is inserted, the plunger 353 makes contact with a switch 354 that provides a signal to the juicer's processor 355. The processor 355 exerts control over and supplies power to the juicer's main motor 356 only when the pusher 62 is inserted. Pushers of this general kind are known from juicers and food processors that utilise a pusher in conjunction with a motor interlock for safety purposes. The interlock's first linkage or contact 352 may be internal to the feed tube and is preferably located at or adjacent to an upper extent of the feed tube.

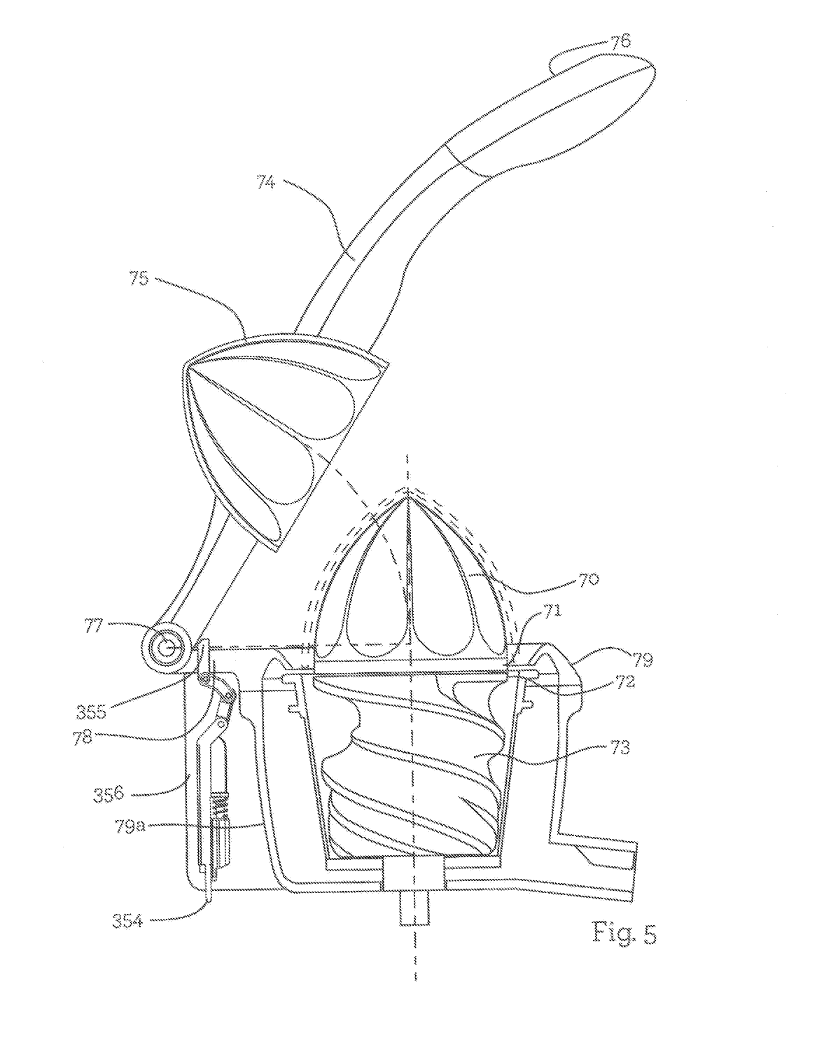

As shown in FIG. 5, the lid and feed tube and processing disk may he removed. With the processing disk removed, the second or inner shaft 33 may be used to directly drive a citrus reamer 70 or other accessory. In preferred embodiments, the removable citrus reamer 70 has a lower edge 71 having a diameter that is approximately the same as the diameter of the upper extent of the auger 72. In this example, the second shaft 33 is preferably rotated at the lower end of a speed adjustment range of a variable speed motor. In the alternative, the underside or shaft or coupling of the reamer 70 may be attached to the auger 73 and rotated by the auger rather than by the second shaft.

The effectiveness of the citrus reamer 70 may be improved by providing a pivoting arm 74 that carries a juicing dome 75. In this example, the arm has a handle 76 at one end and a hinge 77 at the other end. The hinge is carried, for example, by an extension 78 that is affixed to a circumferential rim 79 that is affixable to the lower housing 79a for the juice collection chamber. In practice, the dome 75 urges a half of a citrus fruit onto the reamer 70 and pressure exerts it on the handles 76 improves the extraction of juice from the fruit located between the dome 70. In sonic embodiments, a quadrilateral hinge may be used in place of a simple hinge. A quadrilateral hinge in the context of a citrus juicer is shown in the applicant's published PCT specification WO/2005/041733.

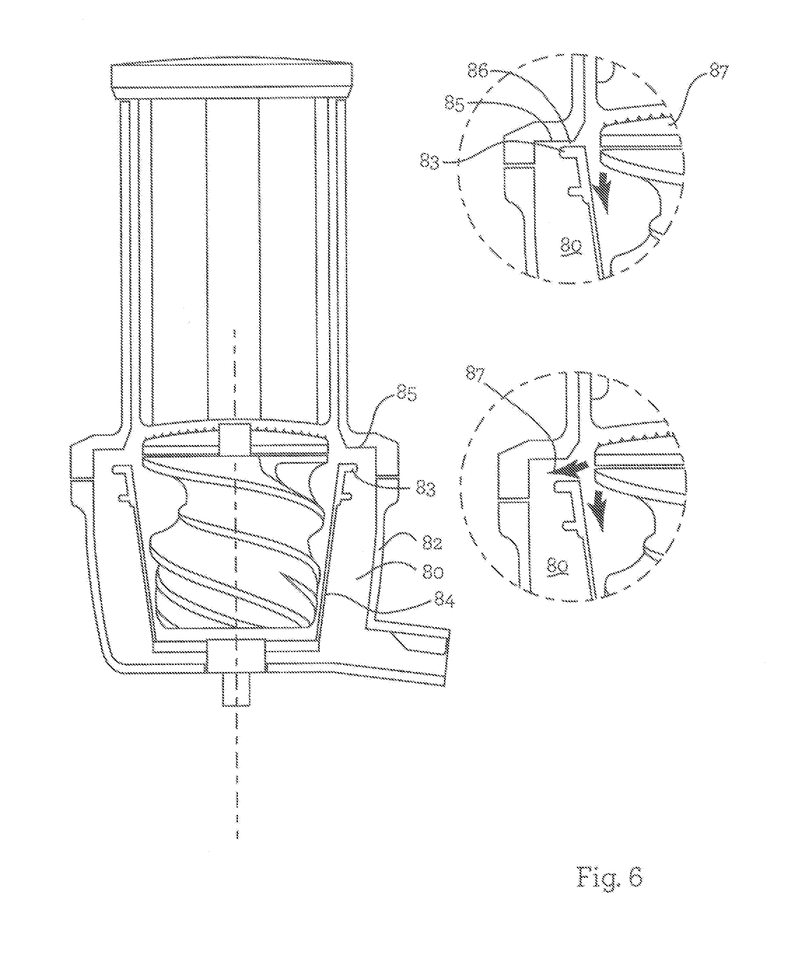

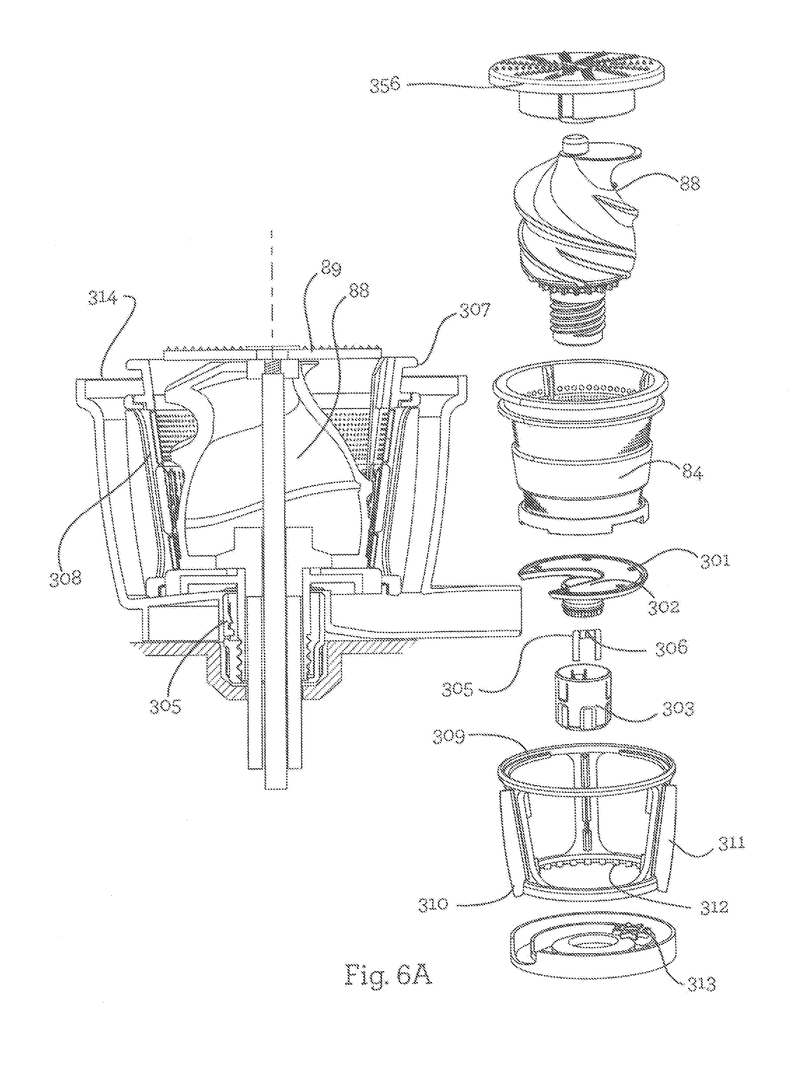

As shown in FIG. 6, the degree of pulp entering the interior 80 of the juice collection chamber 82 can be adjusted by the user. In this example, the gap between the upper rim 83 of the filter basket 84 is adjustable with reference to the underside 8 of the lid. This is done by raising and lowering the filter basket 84 with reference to the stationery underside of the lid 85. When the gap 86 between the rim $3 and the underside 85 is small, a relatively smaller amount of pulp can be discharged by the rotating processing disk 87 into the interior 80 of the juice collection chamber. When the gap 87 is larger, more pulp can be admitted into the interior 80.

The raising and lowering of the filter basket 84 may be accomplished with mechanical means, and electric motor or a solenoid, as required. FIG. 6A provides an example of a device employing filter basket 84 that may he raised or lowered in relation to its auger 88 and processing disc 89. In this example, the lower extremity of the auger 88 terminates in a threaded stub shaft 300. The stub shaft 300 passes through the bottom of the filter basket 84. Optionally, the bottom surface or floor of the filter basket 84 comprises a disc or plate 301 through which is formed a central opening 302 that allows the threads 300 to engage and be rotated with respect to an internally threaded fixture or nut 303. In this example, the filter basket's or plate's central opening 302 is surrounded by a collar having detent features 304. The detent features 304 cooperate with an insert 305 locatable within the nut 303, the insert featuring a protrusion, lip or head 306 for creating a haptic click when the filter basket is rotated relative to the auger 88. Thus, as the filter basket is raised or lowered by rotation, the user is provided with feedback as well as a visual indication of the height of the upper rim 307 of the filter basket 84. In this example, a wiper assembly 308 surrounds the filter basket. The wiper assembly comprises upper and lower rims 309, 310 between which extend vertical members, each one associated with a wiping blade 311. The wiping blade assembly has an array of teeth 312 on an inner periphery that are driven by a gear 313 located below the filter basket. This causes the array of blades 311 to rotate relative to the filter basket so that they may wipe clean the interior of the container 314 in which the auger and filter basket are located. It will be appreciated that the components in the mechanism for raising and lowering the filter basket (300, 301, 304, 303, 305) are similar to the components in a mechanism for raising and lowering the blade of an adjustable blade assembly commonly associated with food processors. Varied thickness blades of this type are sold by the applicant.

As shown in FIG. 7, an increased juice collection volume into a receptacle or container 90 is achieved by raising the location of the juice spout 91 closer to the upper rim 92 of the juice collection chamber rather than the lower spout location illustrated, for example, in FIG. 1 through FIG. 6. In order propel the liquid contents of the juice collection chamber toward the elevated spout 91, the drive shafting is provided with a rotating impeller 93. Rotation of the impeller 93 can be achieved, for example, by a third, cylindrical, shaft 94 that rotates at a higher speed than the shaft that drives the auger 95 In another example, the impeller is affixed to the filter basket 96 whereby the filter basket 96 and impeller 93 are both rotated at relatively high speed relative to the rotational speed of the auger 95. In another example, a gearing arrangement is used to drive the impeller 93 at a higher speed than the auger 95.

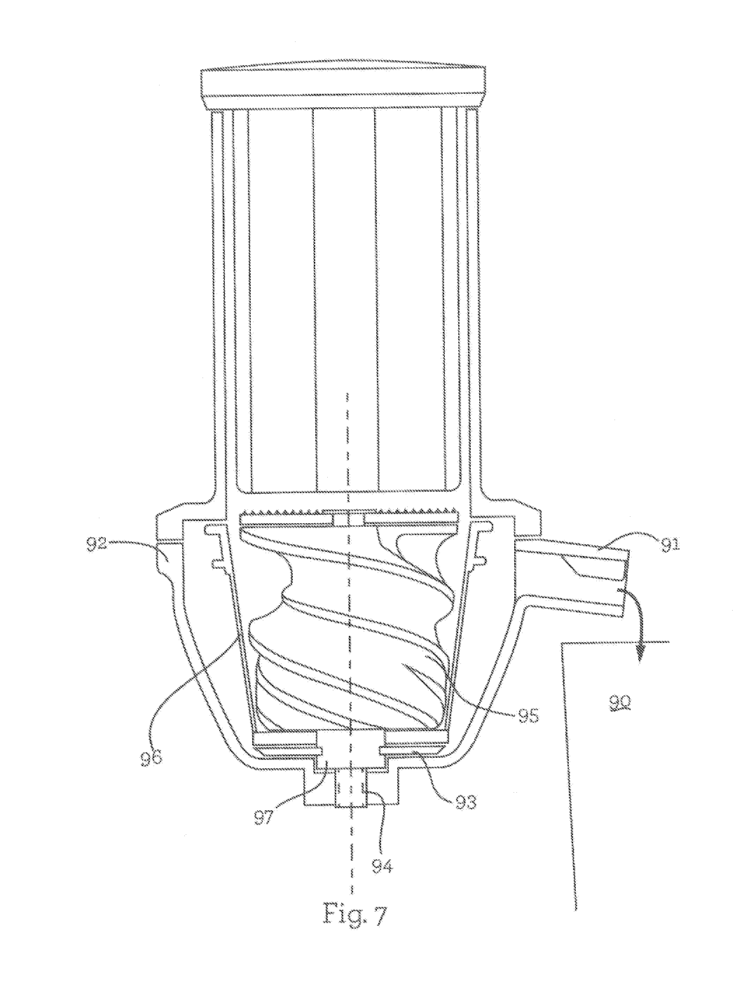

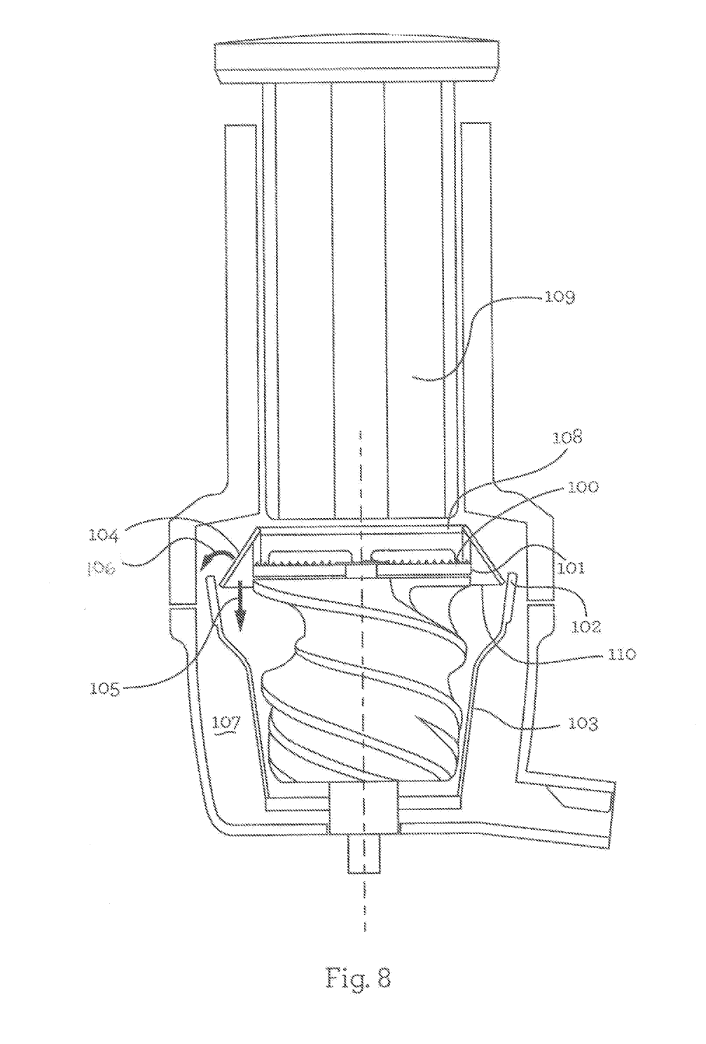

As shown in FIG. 8, the amount of juice entering the interior of the filter basket (and thus potentially wasted) can be reduced by locating the upper surface 100 of the processing disk um above the rim 102 of the filter basket 103. in this example, this is achieved by locating a stationery or rotating, truncated conical primary filter 104 in the horizontal plane defined by the upper surface too of the processing disk 101. This primary filter 104 traps pulp and directs it downwardly 105 into the filter basket 103 for further juice extraction. However, juice 106 passes through the primary filter 104 and into the interior 107 of the juice collection chamber. The upper opening 108 of the primary filter 104 is large enough to accommodate the diameter of the pusher 109. The lower edge 110 of the primary filter is located below the grating disk 101 and below the upper rim 102 of the filer basket 103.

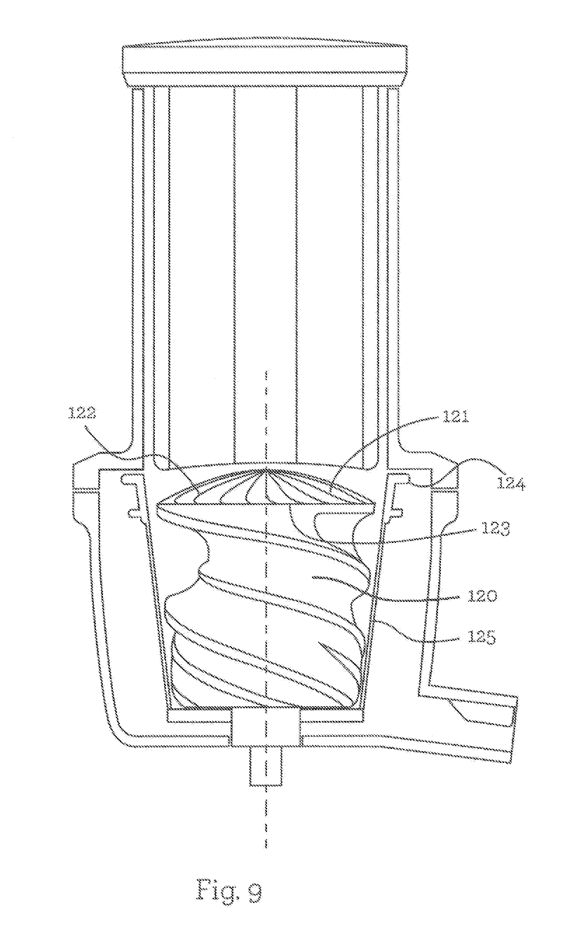

As shown in FIG. 9, the auger 120 may be provided with an upper working surface or integral head 121 that incorporates multiple teeth or ribs 122 that are used to chip, cut, abrade or otherwise mechanically degrade the fruit or vegetables delivered from the feed tube prior to processing by the auger and filter basket. In preferred embodiments, the auger head 121 is integral with the auger but the teeth 122 may be post-machined, inserted, applied or otherwise fastened to the head. In this e ample, the teeth are generally radially arranged across the full diameter of the head 121. In this example, the head 121 is convex, but the bead may also be flat or concave as previously suggested and carry a coring bore. In preferred embodiments, at least the lower edge 123 of the head, if not the entirety of the head, is located below the upper rim 124 of the filter basket 125. In this embodiment, a second shaft and separate processing disk is not required.

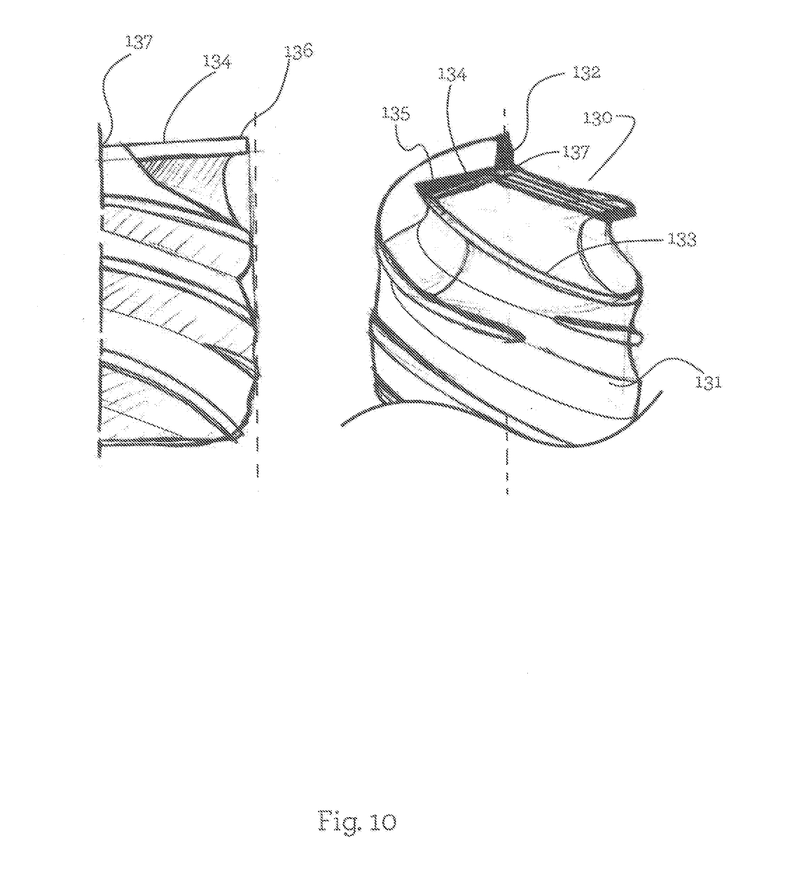

As shown in FIG. 10, the upper extent or upper face 130 of an anger 131 may be provided with a plurality of radially extending cutting edges 132. In this example, the upper portion of the auger 131 has the terminal portions of three separate threads 133. Each thread terminates in a radially extending edge 34 and each edge 134 is either sharpened or carries a separately inserted or separately applied cutting edge 135.

In some examples, each edge 134 is radially inclined with reference to the horizontal so that the outer tip 136 of each edge is higher in elevation than the centre of the auger 137 at its upper extent.

As shown in FIG. 11, the upper or food contacting portion 140 of the auger 141 comprises an array of radially extending teeth 142 such teeth have sharpened edges 143 that aggressively mill food into smaller pieces. Relatively deep, vertically inclined scallops or grooves 144 between the teeth 142 guide broken down food matter, being inclined, into the filter basket.

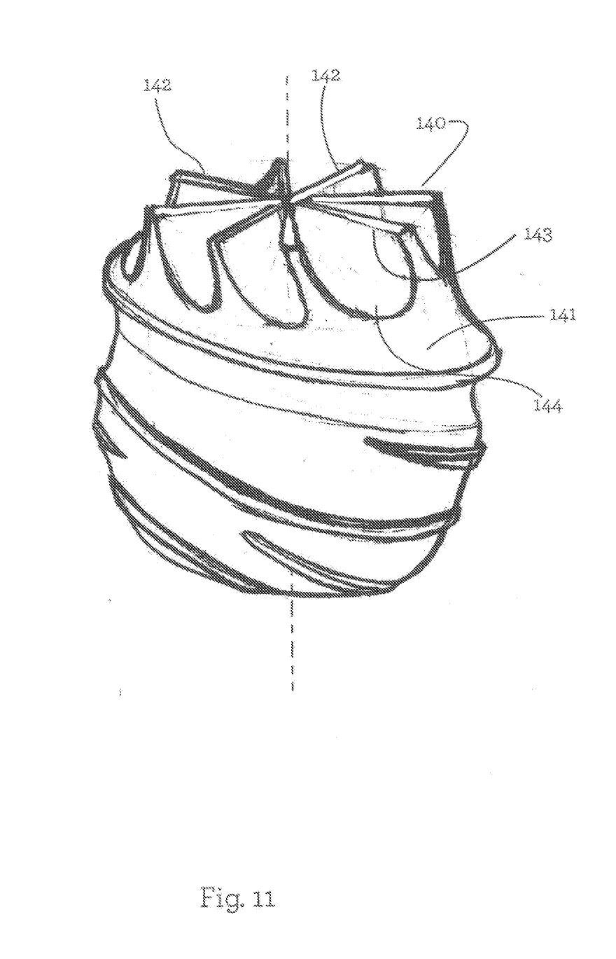

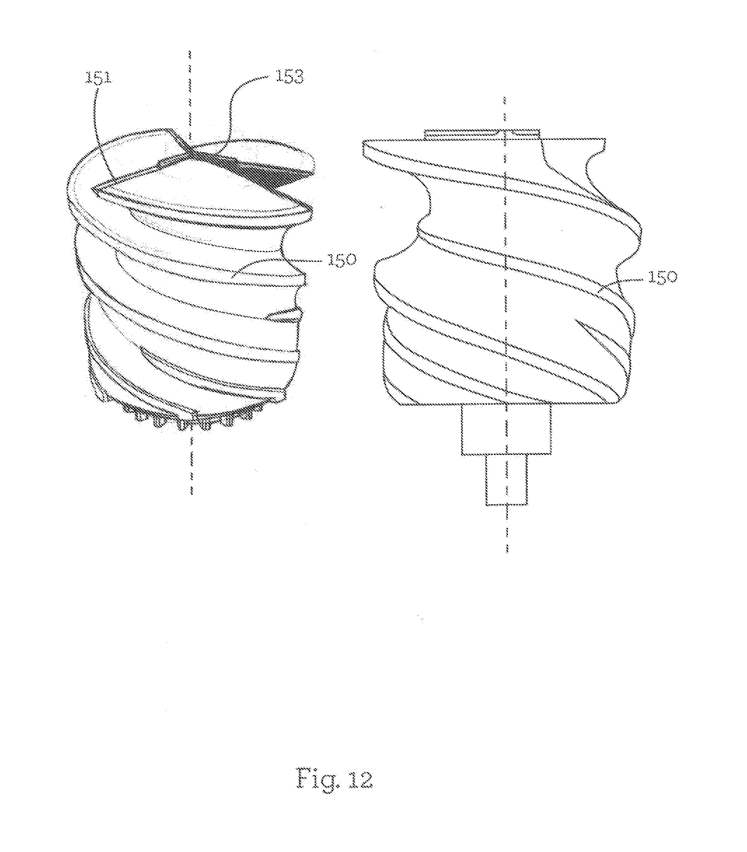

As an alternative to the generally upright and slightly inclined teeth 142 depicted in FIG. 11, the example of FIG. 12 illustrates the auger threads 150 terminating in relatively flat slicing edges 151. The slicing edges 151 are sharp to assist in the breakdown of food material. The edges 151 may be integral with the auger or moulded or applied separately using metal or hard polymers. In addition, the auger depicted in FIG. 12 is provided with slightly elevated coring blades 153 that provide more aggressive breakdown of food material in that area of the auger where the apparent or linear velocity of the cutting edge is lowest. In preferred embodiments, the coring blades 153 are metallic and applied separately or moulded into the auger.

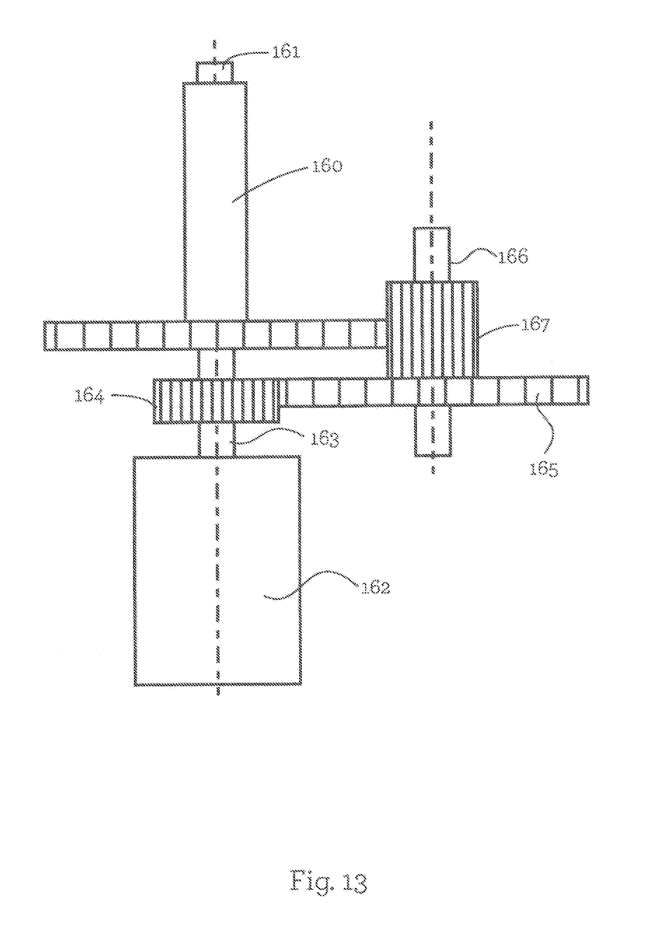

As shown in FIG. 13, a concentric, shaft, arrangement for driving the auger and processing disk depicted in FIG. 1 comprises, for example, an outer shaft or tube shaft 160 and an inner shaft 161 that are driven from a single electric motor 162 but that rotate at different speeds. In this example, the output shaft 163 of the motor drives a first pinion gear 164. The first pinion gear 164 drives a second or reduction gear 165 having a larger diameter than the first pinion gear. The second gear 165 is carried by a shaft 166 that also carries a third or pinion gear 167. The third gear 167 is smaller in diameter than the second gear 165 and smaller in diameter than a fourth gear 168 that is attached to the tube shaft 160. Accordingly, the first shaft 161 operates at the speed of the output shaft 163 while the second shaft 160 is gear reduced by the effect of the gear train comprised of the first, second, third and fourth gears 164, 165, 167 and 168.

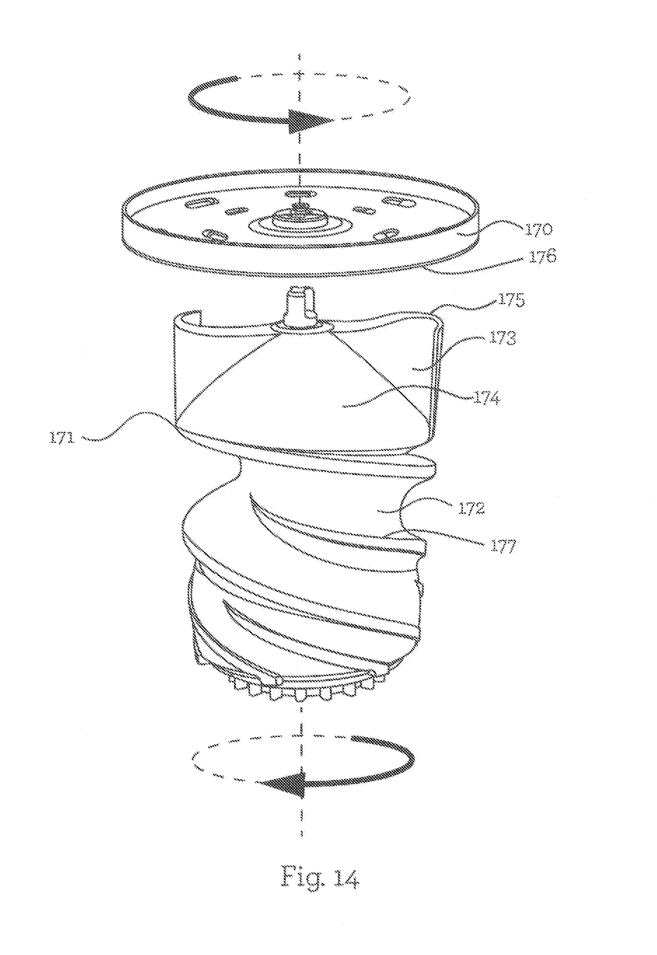

FIG. 14 also illustrates how the juicing action may be improved and accelerated by a counter-rotating shredding disk 170. This shredding disk or processing dusk 70 is approximately the same diameter as the upper extent 15 of the auger. However, it is supported by and rotated by a second shaft that rotates within the cylindrical or tube shaft, that rotates the auger 172. A shredding disk 170 is preferably metallic and has upward facing shredding profiles. The configuration of the teeth and resembles those features found on conventional food processing devices such as those provided commercially by the applicant and others.

Shredded food is collected by sweeping arm details 173 integral to the tapered auger 172. In addition to the integral sweeping arm profile, its proposed that the tapered auger rotates in a counter direction to the shredding disk. The upper edge 175 of each arm is in close proximity to the underside 176 of the disk 170.

The sweeping arm detail 173 of tapered auger 172 may be either integral to the tapered auger, or comprise an inserted dissimilar material, assembled to the auger body. In this example the top of the auger 174, adjacent to the sweeping arms is tapered or conical to better allow food to descent to the auger's threads 177.

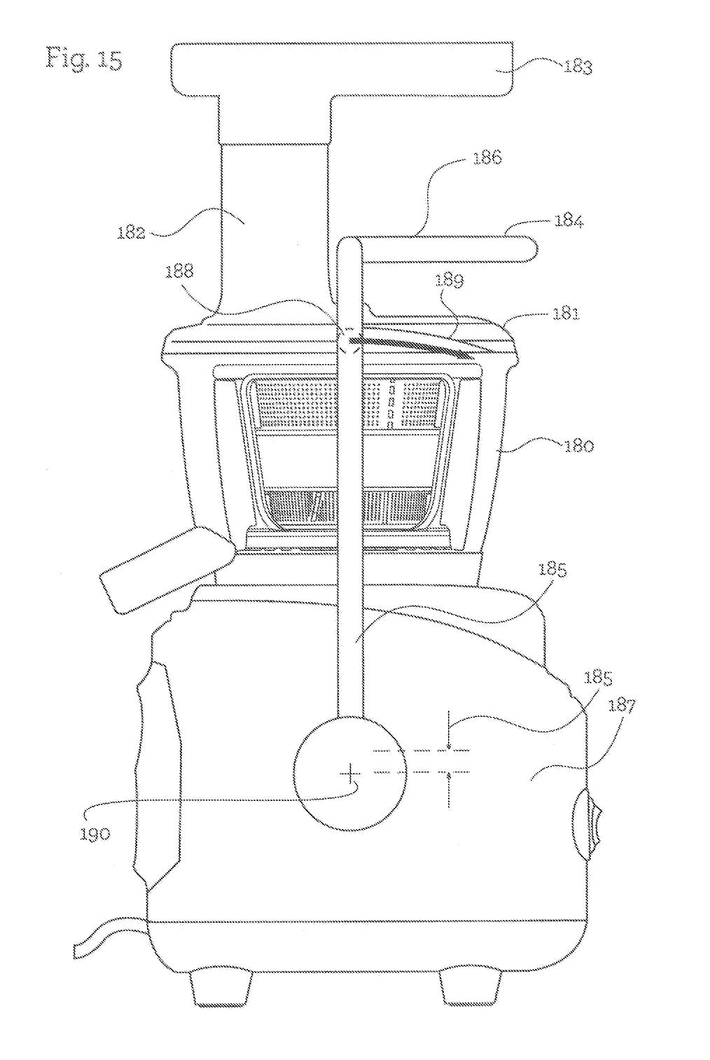

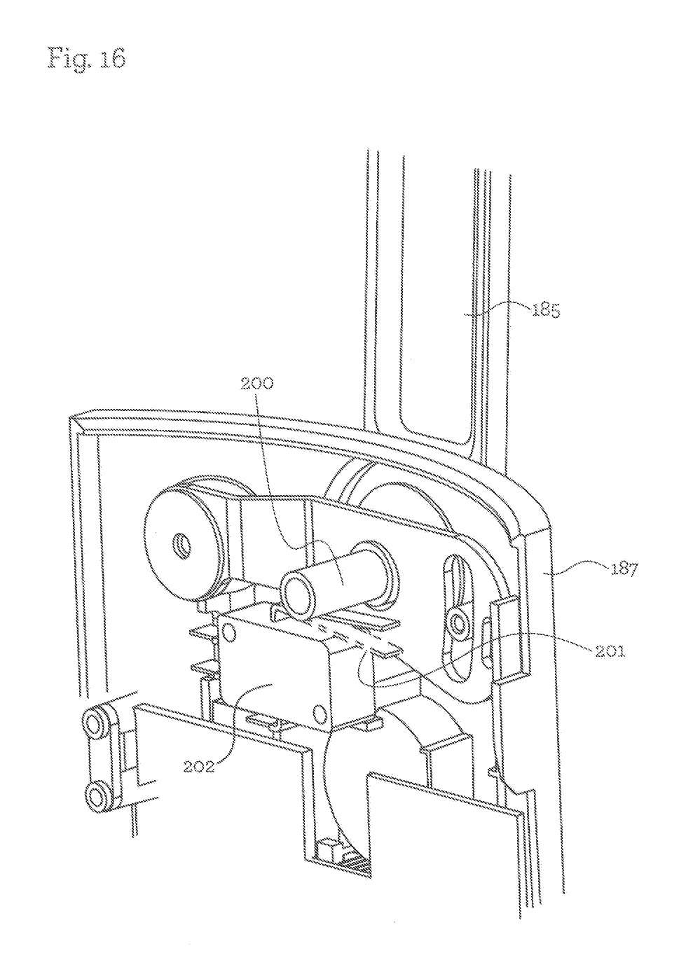

As shown in FIGS. 15 and 16, the juice collection chamber 180 has a lid 181 that incorporates a feed tube 182 and an optional food platform and chute 183. In this example, the lid 181 is retained by a safety bar 184. The safety bar 184 is of the type frequently seen in juicers manufactured by the applicant. As known in the juicer art, the safety bar 184 comprises a pair of descending arms 185 that are interconnected at their upper Buds by a curved handle 186. The safety bar pivots about the juicer's base 187. The safety bar has a pair of inward facing protrusions 188 that make contact with and ride over a pair of ramped surfaces 189 that are formed on the upper surface of the lid 181. As the safety bar is raised into its upright and locked orientation, the centre 190 of the pivot is displaced upwardly 191. This upward motion of the pivot shaft 200 (as shown in FIG. 16) allows, for example, the movement of the contact 201 of a switch or micro switch 202 to move from an open contact position to a close contact position (or vice versa) so as to communicate to the juicer's processor that the safety bar is in its upright and locked orientation. This allows the processor to exert control over a motor controller or directly over the motor itself.

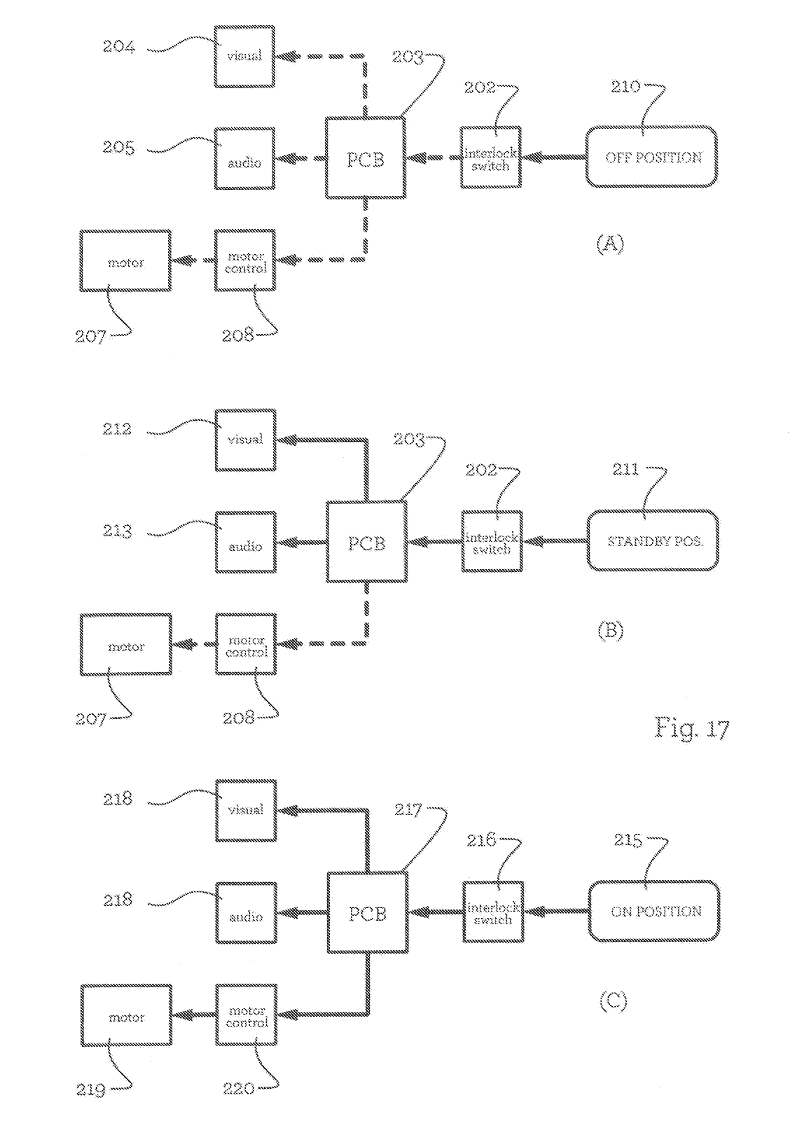

As shown in FIG. 17(a) when the safety bar 185 is other than in an upright or locked orientation 210, the micro switch or interlock switch 202 either does not communicate with the juicer's processor 203 or communicates a signal that represents that the safety bar is not in its upright or locked orientation. Accordingly, the processor 203 provides no visual indication of readiness 204, audio signal representing readiness to operate 205 or control over the juicer's motor 207 or its motor controller 208. FIG. 17(b) represents a standby position in which the safety bar 185 is in an upright position but where a user operable switch to operate the motor has not yet been activated by a user 211. In this orientation, the interlock or micro switch 202 is activated and communicates with the juicer's micro processor 203. The zero processor 203 may then cause a visual indication of readiness 212, such as a light or indication on a graphic display. The micro processor 203 may also cause and audible signal to be emitted 213. The audio signal may be a sound or tone indicating that the unit is ready to operated. However, because the primary motor control switch has not been inactivated, the micro processor 203 does not cause the juicer's motor 207 or its motor control 208 to operate. As shown FIG. 17(c) when the safety bar is in the upright or locked orientation 215, the interlock or micro switch 216 communicates with the juicer's processor 217, in effect acting as an instruction for the process to cause either or both of a visual indication of readiness 218, an audio tone indicating readiness and simultaneously allowing the processor 217 to operate or either the motor 219 or the motor's controller 220, as required.

As shown in FIG. 18, a juicer in accordance with the previous teachings may be provided with a user interface 230. In this example, the user interface comprises a master power switch 231, and LCD or other graphic display panel 232 and a rotary knob 233 for controlling the motor speed. In this example, when the knob 233 is at its counter clockwise limited, no power can be delivered to the juicer's motor. As suggested by FIG. 18(a) when the master power switch 231 is in the off position, no segments are activated or illuminated on the display panel 232. As suggested by FIG. 18(b) activation of the master power switch 213 causes a corresponding activation of the graphic display panel 232. In the example of FIG. 18(b) the safety bar 234 is not in the upright and locked position. For this reason, and owing to the operation on the lock out on micro switch 202 (see FIG. 16) an indication is provided on the graphic display panel that the safety bar or lock bar must be raised into its upright and locked orientation. In this example, the graphic display panel 232 provides a graphic indication in the form of a “L” 235.

As suggested by FIG. 18(c), when the master power switch 231 is in the “on” position and the rotary knob 233 is advanced to its lowest setting, a first indicator in an array 237 of indicators is activated or illuminated. The array 237 in this example comprises a linear array of five segments. Each segment is associated with a word or words 238 that represent food products such as fruits or vegetables. In this example, the lowest setting corresponds to the term “soft fruit”, representative of fruit such as plums, peaches or bananas. The next highest setting is a adjacent to and represents “citrus” being citrus fruits. The third segment is adjacent and represents harder fruits and in this example “Pineapple”. The fourth segment is adjacent to and represents “apple”. The fifth and final segment is adjacent to and represents “hard veg” being a hard vegetable such as a carrot or beet root As suggest by FIG. 18(d) adjacent segments 239 may be activated or illuminated simultaneously. This represents a setting between two other settings. In this example, both “soft fruit” and “citrus” are activated or illuminated. This represents a setting between the settings depicted in FIGS. 18(c) and 18(e), being “soft fruit” and “citrus”. An alphanumeric display 240 provides another graphic indication of motor speed, a numeral. In this example, the numerals 1 through 5 are illuminated sequentially in response to the rotation of the motor speed control knob 233.

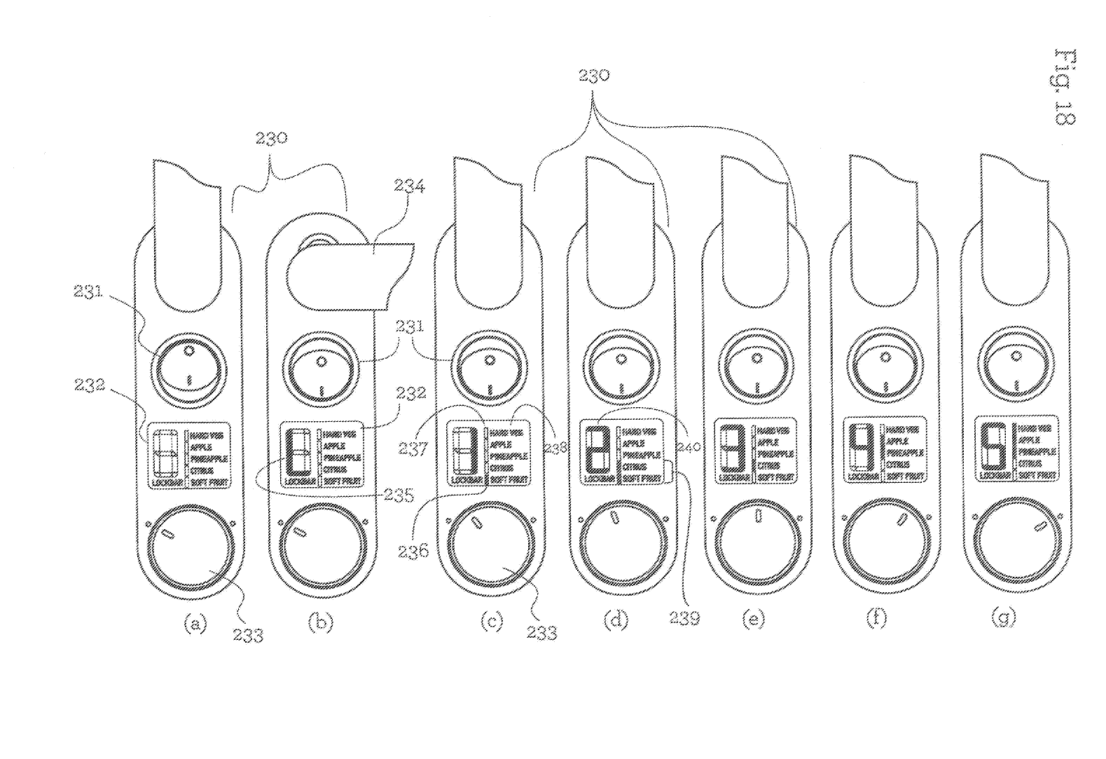

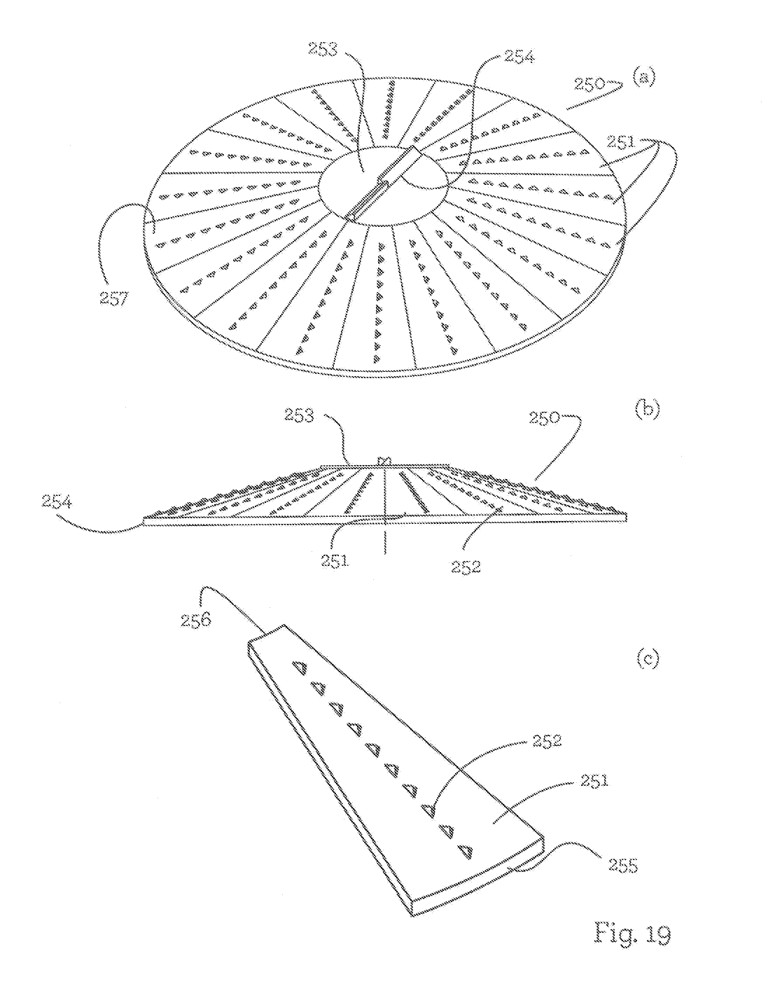

As shown in FIG. 19, a grating disk 250 may be formed from similar or identical segments 251. In this example, each segment comprises a wedge shape or tapered, but truncated, segment of a circle. Each segment 251 is characterised by one or more arrays 252 of cutting or grating teeth as are common in grating disks found on centrifugal juicing machines. The central part of the grating disk 251 is preferably flat 253 and contains within it one or more coring knives 254 the land conventionally found in centrifugal juicing grating disks. Adjacent segments 251 are joined by welding. Although the grating disk may he flat, the grating disk 250 depicted in FIG. 19 is convex, the central region 253 being at a higher vertical elevation than the peripheral edge 254. Using the same fabrication technique, the grating disk may he fabricated as a concave shape, with a central region 253 located below the peripheral edge 254. In this example, both the outer edge 255 and the inner edge 256 of a segment 251 are curved. The curvature of the outside edge 255 corresponds to the diameter of the grating disk 250 whereas the curvature of the inner edge 256 corresponds to the diameter of the central region 253.

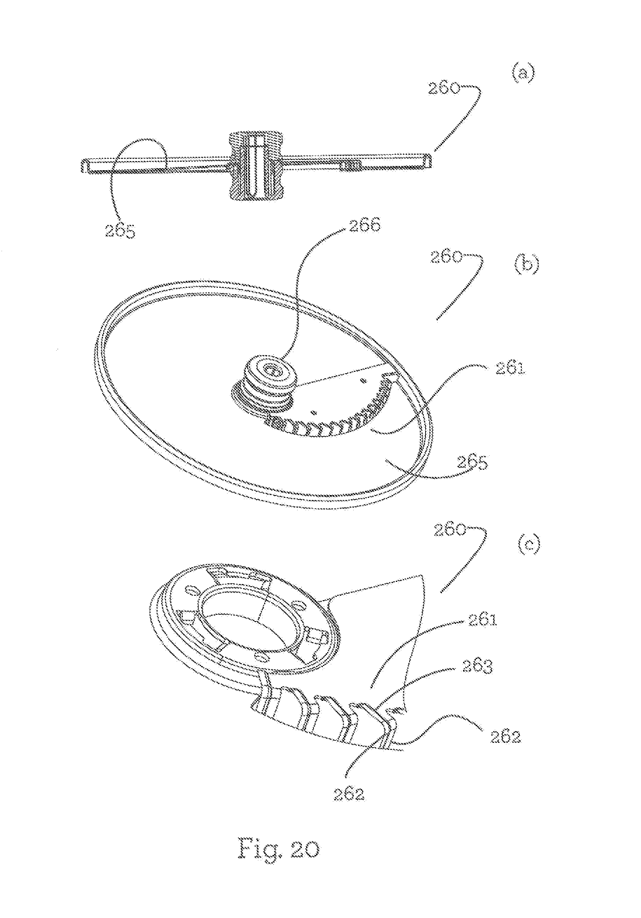

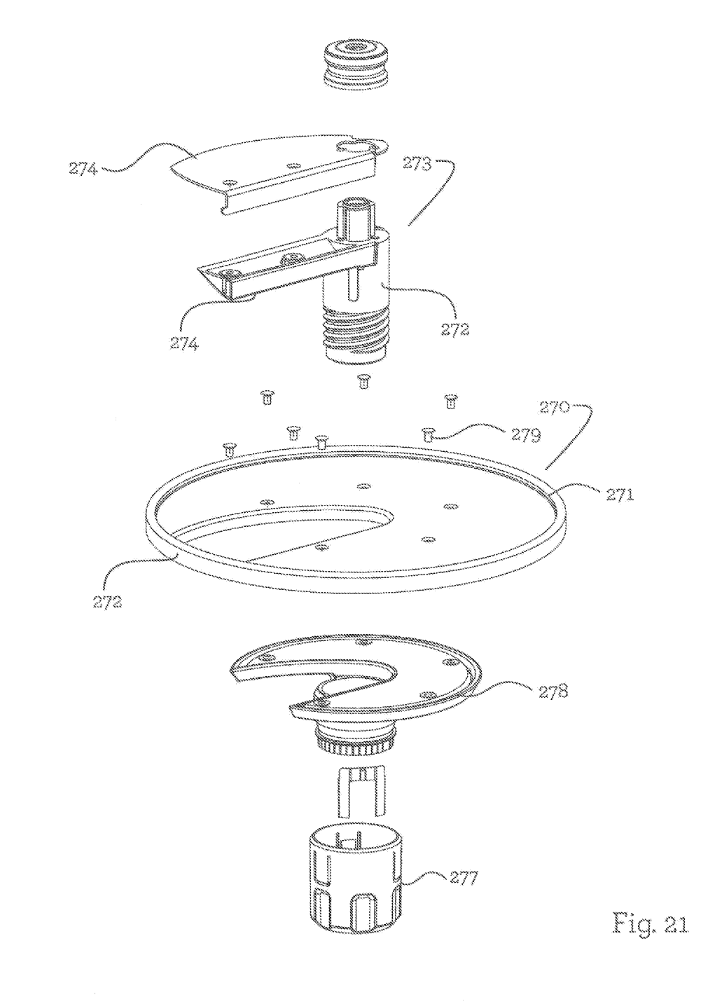

As suggested by FIGS. 1-4, 9 and 14, a variety of different processing disks may be used in conjunction with an auger of the kind previously described. As mentioned, the processing disk is capable of rotating faster than the auger and may rotate in a contrary direction. FIGS. 20 and 21 illustrate two alternative forms of processing disk that may he used in conjunction with the auger, in the manner suggested by FIG. 14. As illustrated in FIG. 20, the processing disk 260 may include a chopping or cubing blade array 261. In the array 261 each individual blade 262 is bent or radiused and has cutting edges along both a horizontal edge 263 and a vertical edge 264. The edges are located above the upper surface 265 of the processing disk 260. The huh 266 is adapted to cooperate with and engage the shaft (e.g. 33 in FIG. 1) and the diameter of the disk 260 is approximately the same as the diameter of the upper extremity of the auger. As shown in FIG. 21, the processing disk may be a variable thickness cutting disk. Disk of the kind depicted in FIGS. 20 and 21 are commonly known in food processors, for example food processors manufactured by the applicant. In this example, the variable thickness cutting disk comprises a flat primary disk 271. The primary disk 271 has a relief area 272 that accommodates a cutting blade assembly 273 comprises a metallic blade 274 that is supported by a threaded spindle 275 having a cantilever portion 276 at an upper extremity. The spindle 275 and its blade 274 are raised and lowered by rotating a collar 277 located below a supporting hub 278 that is affixed to the primary disk 271 by fasteners 279.

As previously mentioned, examples of fruit and vegetable juicers appear in the applicant's Australian patent application number 2013901411 and granted Australian patent number 684615.

Although the technology has been described with reference to specific examples, it will he appreciated by those skilled in the art that the technology may be embodied in many other forms.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment of the present technology. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would he apparent to one of ordinary skill in the art from this disclosure, in one or more embodiments.

Similarly it should be appreciated that in the above description of exemplary embodiments of the technology, various features of the technology are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed technology requires more features than are expressly recited in each claim. Rather, as the following claims reflect, inventive aspects lie in less than all features of a single foregoing disclosed embodiment. Any claims following the Detailed Description, are hereby expressly incorporated into this Detailed Description, with each claim standing on its own as a separate embodiment of this.

Furthermore, while some embodiments described herein include some but not other features included in other embodiments, combinations of features of different embodiments are meant to be within the scope of the technology, and form different embodiments, as would be understood by those in the art. For example, in the following claims, any of the claimed embodiments can be used in any combination.

Thus, while there has been described what are believed to be the preferred embodiments of the technology, those skilled in the art will recognize that other and further modifications may be made thereto without departing from the spirit of the technology, and it is intended to claim all such changes and modifications as fall within the scope of the technology.

While the present technology has been disclosed with reference to particular details of construction, these should be understood as having been provided by way of example and not as limitations to the scope or spirit of the technology.

What is claimed is:

1. A motorised juicer for fruit and vegetables, comprising:
a juice collection chamber within which is located a filter basket;
the filter basket having an upper rim and having within it an augur with helical threads;
the auger being driven by a first shaft that is a cylinder;
a second shaft passing through the first shaft so as to independently rotate a processing disk that is located above the augur.

2. The juicer of claim 1, wherein:
the filter basket has an upper rim and the augur and processing disk are below the rim.

3. The juicer of claim 1, wherein:
the juice collection chamber supports a lid having a feed tube that is centrally located and has a diameter that is approximately the same as the diameter of the processing disk.

4. The juicer of claim 1, wherein the juice collection chamber has an upper rim that is lower than the upper rim of the filter basket.

5. The juicer of claim 1, wherein:
an upper surface of the processing disk is concave.

6. The juicer of claim 1, wherein:
an upper surface of the processing disk is convex.

7. The juicer of claim 1, wherein:
the processing disk is removeable.

8. The juicer of claim 7, wherein:
the processing disk is replaceable with a citrus reamer.

9. The juicer of claim 1, wherein:
the processing disk is a grating disk.

10. The juicer of claim 1, wherein:
the processing disk is a shredding disk.

11. The juicer of claim 1, wherein:
the processing disk is a slicing disk.

12. The juicer of claim 1, wherein:
the processing disk rotates in one direction and the augur rotates in an opposite direction.

13. The juicer of claim 1, wherein:
a single motor rotates both the processing disk and the augur;
the augur and processing disks being rotate at different speeds.

14. The juicer of claim 1, wherein:
the juice collection chamber supports a lid with a feed tube; and
the lid is retained by a safety bar.

15. The juicer of claim 14, wherein:
the juicer has a base; and
the safety bar pivots about the base.

16. The juicer of claim 14, wherein:
the safety bard is associated with a switch that is an interlock switch that allows the juicer to operate when the safety bar is in an upright orientation.

17. The juicer of a claim 1, wherein:
the filter basket maybe raised or lowered.

18. The juicer of claim 3, wherein;
the feed tube receives a pusher;
the pusher cooperating with an interlock that prevents the juicer's motor from operating unless the pusher is inserted into the feed tube.
